(19) United States
(12) Patent Application Publication
(10) Pub. No.: US 2025/0283845 A1
(43) Pub. Date: Sep. 11, 2025

(54) THREE ELECTRODE CELL INCLUDING SOLID ELECTROLYTE

(71) Applicant: Schaeffler Technologies AG & Co. KG, Herzogenaurach (DE)

(72) Inventors: Kewei LIU, Wadswoth, OH (US); Arian KHATIBI, Wooster, OH (US); Chan-Yeop YU, Wooster, OH (US); Joshua DUNHAM, Orrville, OH (US); Rashid FARAHATI, Copley, OH (US); Raziyeh GHAHREMANI, Wooster, OH (US)

(21) Appl. No.: 18/596,091

(22) Filed: Mar. 5, 2024

(51) Int. Cl. G01N 27/30; H01M 4/134; H01M 10/058

(52) U.S. Cl. CPC G01N 27/301; H01M 4/134; H01M 10/058; H01M 2300/0065

(57) ABSTRACT

A three electrode cell includes an anode, a cathode, a solid electrolyte between the anode and the cathode, an elongated reference electrode embedded in the solid electrolyte, and a housing surrounding the anode, the cathode and the solid electrolyte. The reference electrode extends out of the housing.

### TECHNICAL FIELD

The present disclosure relates generally to three electrode cells, and more specifically to three electrode cells including solid electrolyte.

### BACKGROUND

The performance of All Solid State Batteries (ASSB) are highly dependent on the quality of the anode and cathode laminate. However, in a regular full cell study, the performance of the anode and cathode are all combined with each other. Hence, it is very difficult to do the diagnostics of the cell based on electrochemical data to distinguish the issues from cathode and anode, especially for ASSB. Thus, three electrode cells are used in laboratory setting and include a reference electrode to test electrochemical data of the anode and cathode.

### SUMMARY

A three electrode cell includes an anode, a cathode, a solid electrolyte between the anode and the cathode, an elongated reference electrode embedded in the solid electrolyte, and a housing surrounding the anode, the cathode and the solid electrolyte. The reference electrode extends out of the housing.

In examples, the reference electrode is a wire.

In examples, the wire has a diameter of between 0.1 and 0.5 mm.

In examples, the reference electrode is formed of lithiated aluminum.

In examples, the reference electrode passes entirely through the solid electrolyte and the housing with a first end of the reference electrode being outside of the housing and a second end of the reference electrode being outside of the housing.

In examples, the housing includes a hollow body including a bore receiving the anode, the cathode, and the solid electrolyte, the reference electrode extending through a first hole in the hollow body into the bore.

In examples, the reference electrode extends through a second hole in the hollow body into the bore such that a first end of the reference electrode and a second end of the reference electrode, opposite of the first end, are positioned outside of the hollow body.

In examples, the hollow body is formed of a ceramic material.

In examples, the housing further includes a first plunger configured for being inserted into a first end of the bore to contact the anode and a second plunger configured for being inserted into a second end of the bore to contact the cathode.

In examples, the first plunger and the second plunger are formed of stainless steel, tungsten, or nickel coated stainless steel.

In examples, the hollow body is formed of a ceramic material or PEEK.

In examples, the housing further includes a casing surrounding the hollow body, the casing including a first hole aligned with the first hole of the hollow body and a second hole aligned with the second hole of the hollow body, the reference electrode extending through the first hole and the second hole of the casing.

In examples, the casing includes a first section and a second section that are removably connected to each other, the housing further including a first plunger configured for being inserted through the first section of the casing and into a first end of the bore to contact the anode and a second plunger configured for being inserted through the second section of the casing and into a second end of the bore to contact the cathode, a first plunger seal being sandwiched between the first plunger and the first section of the casing, a second plunger seal being sandwiched between the second plunger and the second section of the casing.

In examples, the housing further includes a first adapter configured for being inserted through the casing and into the hollow body and a second adapter configured for being inserted through the casing and into the hollow body, the first adapter including a first hole configured for the reference electrode to pass through, the second adapter including a second hole configured for the reference electrode to pass through,

In examples, the first adapter includes a first inner adapter section configured for being inserted through the casing and into the hollow body and a second inner adapter section configured for being inserted through the casing and into the hollow body, a first inner seal being sandwiched between the first inner adapter section and the hollow body, and a second inner seal being sandwiched between the second inner adapter section and the hollow body.

In examples, the housing further includes a first outer adapter section configured for being inserted into the first inner adapter section and a second outer adapter section configured for being inserted into the second inner adapter section, the first inner adapter section including a first hole forming a portion of the first hole of the first adapter, and the first outer adapter section including a first hole forming a portion of the first hole of the first adapter, the second inner adapter section including a second hole forming a portion of the second hole of the second adapter, and the second outer adapter section including a second hole forming a portion of the second hole of the second adapter, a first outer seal being sandwiched between the first inner adapter section and the first outer adapter section, and a second outer seal being sandwiched between the second inner adapter section and the second outer adapter section.

A method is also provided including stacking the anode, the cathode, and the solid electrolyte in a hollow body of the housing; and then inserting the reference electrode through the hollow body and the solid electrolyte.

In examples, the method further includes, after the stacking and before the inserting: installing a casing of the housing onto the hollow body; and inserting a first adapter through the casing and into contact with the hollow body and inserting a second adapter through the casing and into contact with the hollow body, the inserting of the reference electrode including inserting a first end the reference electrode through the first adapter, through the casing, through the hollow body and through the second adapter.

In examples, the method further includes, prior to the stacking, installing a portion of a first plunger into the hollowing body, the stacking including stacking the anode, the cathode, and the solid electrolyte in the hollow body on the portion of the first plunger.

### BRIEF DESCRIPTION OF THE DRAWINGS

The present disclosure is described below by reference to the following drawings, in which:

FIG. 1 shows a radial cross-sectional view of a three electrode cell according to the present disclosure;

FIG. 2 schematically shows an anode, a cathode and a solid electrolyte of the three electrode cell; and

FIG. 3 shows an exploded view of the three electrode cell.

### DETAILED DESCRIPTION

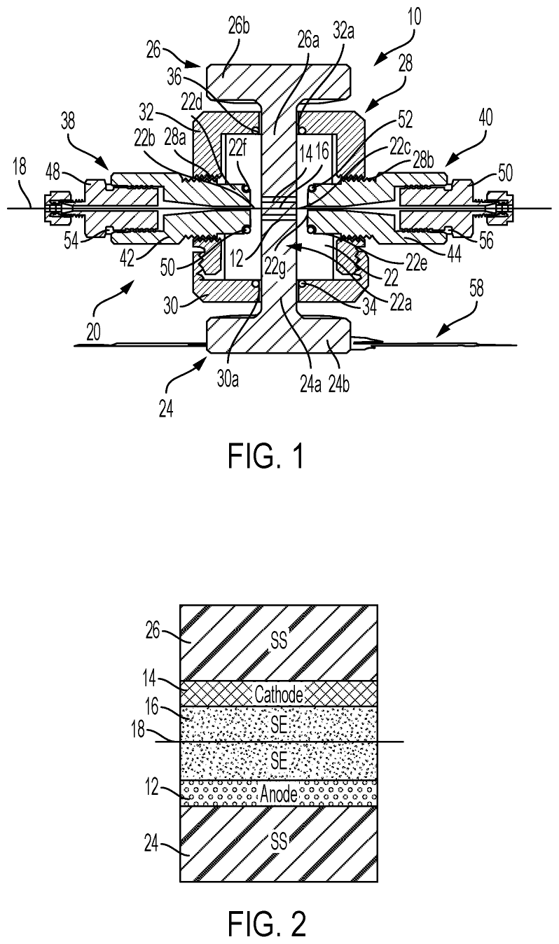

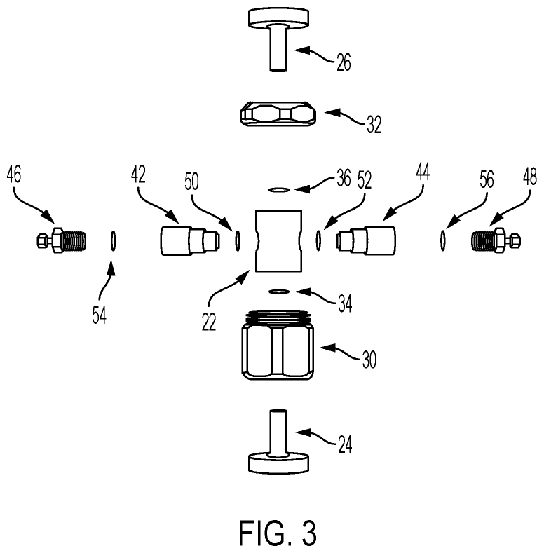

FIG. 1 shows a radial cross-sectional view of a three electrode cell 10 according to the present disclosure; FIG. 2 schematically shows an anode 12, a cathode 14 and a solid electrolyte 16 of three electrode cell 10, and FIG. 3 shows an exploded view of three electrode cell 10. An elongated reference electrode 18, which may be a wire, is embedded in the solid electrolyte 16. Solid electrolyte can be added on both sides to compress the reference electrode 18. A housing 20 surrounds the anode 12, the cathode 14, and the solid electrolyte 16. The reference electrode 18 extends out of the housing 20. More specifically, the reference electrode 18 passes entirely through the solid electrolyte 16 and the housing 20 with a first end 18a of the reference electrode 18 being outside of the housing 20 and a second end 18b of the reference electrode 18 being outside of the housing 20.

In some examples, the reference electrode 18 is formed of lithiated aluminum, with an entire outer surface of the electrode being lithiated. The reference wire can have a diameter of between 0.1 and 0.5 mm.

The housing 20 may include a hollow body 22 comprising a bore 22a for receiving the anode 12, the cathode 14, and the solid electrolyte 16, with the reference electrode 18 extending through a first hole 22b and a second hole 22c in the hollow body 22. The hollow body 22 may be a ceramic material or PEEK.

The housing 20 may further include a first plunger 24 configured for being inserted into one end of the bore 22a to contact the anode 12, and a second plunger 26 configured for being inserted into the opposite end of the bore 22a to contact the cathode 14. The plungers 24, 26 can be made of stainless steel, tungsten, or nickel coated stainless steel.

The housing 20 may further includes a casing 28 surrounding the hollow body 22. The casing 28 can include a first section 30 and a second section 32, which are removably connected to each other by threads. Sections 30, 32 each have a cup shape and first section 30 is screwed into second section 32 by the outer threads of first section 30 intermeshing with the inner threads of second section 32. Plungers 24, 26 extend through respective holes 30a, 30b in casing 28 such that and end of each of plungers 24, 26 contacts the anode 12 and cathode 14, respectively. To seal the interfaces between plungers 24, 26 and casing 28, plunger seals 34, 36 are provided at these interfaces.

More specifically, first section 30 includes the hole 30a and second section 32 includes the hole 32a, such that plunger 24 extends through first section 30 and plunger 26 extends through second section 32. Plungers 24, 26 each include a pin 24a, 26a forming a narrower portion thereof and a plate 24b, 26b forming a wider portion thereof. Pins 24a, 26b extend through the respective hole 30a, 32a into bore 22a and contact the anode 12 and cathode 14, respectively. Plunger seals 34, 36 contact the outer surface of the respective pin 24a, 24b and contact casing 28 adjacent to the respective holes 30a, 32a. Plates 24b, 26b are positioned outside of casing 28.

The housing 20 further includes adapters 38, 40 for insertion through the casing 28 into the hollow body 22. The housing 20 includes aligned holes allowing the reference electrode 18 to extend through the adapters 38, 40, the casing 28 and the hollow body 22. More specifically, Casing 28 includes holes 28a, 28b, each receiving a respective one of the adapters 38, 40, hollow body 22 includes first hole 22b and second hole 22c through which reference electrode 18 passes in the assembled orientation of three electrode cell 10 and adapters 38, 40 each include a respective hole 38a, 40a through which reference electrode 18 passes in the assembled orientation of three electrode cell 10.

First adapter 38 includes a first inner adapter section 42 and a first outer adapter section 46, along with a first inner seal 50 and a first outer seal 54, while second adapter 40 includes a second inner adapter section 44 and a second outer adapter section 48, along with a second inner seal 52 and a second outer seal 56.

First inner adapter section 42 and second inner adapter section 44 are inserted into opposite sides of casing 28 and pass through casing 28 into contact with opposite sides of hollow body 22. Hollow body 22 includes recesses 22d, 22e on opposite sides of hollow body 22, each for receiving an end of a respective one of first inner adapter section 42 and second inner adapter section 44 such that the end of the respective section 42, 44 contacts a surface 22f, 22g surrounding the respective hole 22b, 22c. Inner seals 50, 52 are held in recesses 22d, 22e and abut the ends of inner adapter sections 42, 44. Inner adapter sections 42, 44 are removably connected to casing 28 in holes 28a, 28b. Specifically, inner adapter sections 42, 44 are removably connected to casing 28 by threads on the outer circumference of inner adapter sections 42, 44 engaging threads on the inner circumferential of holes 28a, 28b.

First outer adapter section 46 and second outer adapter section 48 are inserted into ends of first inner adapter section 42 and 44, respectively, that face away from hollow body 22 in the assembled orientation of three electrode cell 10. More specifically, each of first inner adapter section 42 and second inner adapter section 44 includes a respective recess 42a, 44a, in the end facing away from the end that contacts hollow body 22, into which the respective outer adapter section 46, 48 is inserted.

A method for constructing the three electrode cell 10 may include stacking the anode 12, cathode 14, and solid electrolyte 16 within the hollow body 22 of the housing 20 and inserting the reference electrode 18 through the solid electrolyte 16. The method can include installing the casing 28 onto the hollow body 22 and inserting the adapters 38, 40 into the casing 28 and in contact with the follow body 22. Prior to the stacking of the anode 12, cathode 14, and solid electrolyte 16 within the hollow body 22, the method can include installing a portion—i.e., pin 24a—of the plunger 24 into the hollow body 22 and resting plate 24b of plunger on a support surface 58. After the anode 12, cathode 14, and solid electrolyte 16 are stacked within the hollow body 22, the pin 26a of plunger 26 is inserted into hollow body. The inserting of the reference electrode 18 includes inserting the first end 18a of the reference electrode 18 through the first adapter 38, through the casing 28, through the hollow body 22 and through the second adapter 40. After this insertion, the first end 18a protrudes in a first direction from the adapter 40 and the second end 18b protrudes in a second direction, opposite of the first direction, from the adapter 38 such that both ends 18a, 18b are outside of the housing 20. Protruding on both side secures the position of the reference electrode, which greatly helps the accuracy of the test.

The electron flow initiated by a test using three electrode cell 10 is continuous flow from anode 12 to cathode 14 during charging and from cathode 14 to anode 12 during discharging. Reference electrode 18 is used to detect the potential difference. When the test is started, current is applied between anode 12 to cathode 14, and the reference electrode 18 is used to monitor the voltage change of anode 12 to cathode 14 at the same time.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### Reference Numerals

10 three electrode cell
12 anode
14 cathode
16 solid electrolyte
18 reference electrode
18a first end
18b second end
20 housing
22 hollow body
22a bore
22b first hole
22c second hole
22d recesses
22e recesses
22f surface
22g surface
24 plungers
24a pin
24b plate
26 plungers
26a pin
26b plate
28 casing
28a holes
28b holes
30 first section
30a respective holes
30b respective holes
32 second section
32a hole
34 plunger seals
36 plunger seals
38 adapters
38a respective hole
40 adapters
40a respective hole
42 first inner adapter section
42a respective recess
44 second inner adapter section
44a respective recess
46 first outer adapter section
48 second outer adapter section
50 first inner seal
52 second inner seal
54 first outer seal
56 second outer seal
58 support surface

What is claimed is:

1. A three electrode cell including:
an anode;
a cathode;
a solid electrolyte between the anode and the cathode;
an elongated reference electrode embedded in the solid electrolyte; and
a housing surrounding the anode, the cathode and the solid electrolyte, the reference electrode extending out of the housing.

2. The three electrode cell as recited in claim 1 wherein the reference electrode is a wire.

3. The three electrode cell as recited in claim 2 wherein the wire has a diameter of between 0.1 and 0.5 mm.

4. The three electrode cell as recited in claim 1 wherein the reference electrode is formed of lithiated aluminum.

5. The three electrode cell as recited in claim 1 wherein the reference electrode passes entirely through the solid electrolyte and the housing with a first end of the reference electrode being outside of the housing and a second end of the reference electrode being outside of the housing.

6. The three electrode cell as recited in claim 1 wherein the housing includes a hollow body including a bore receiving the anode, the cathode, and the solid electrolyte, the reference electrode extending through a first hole in the hollow body into the bore.

7. The three electrode cell as recited in claim 6 wherein the reference electrode extends through a second hole in the hollow body into the bore such that a first end of the reference electrode and a second end of the reference electrode, opposite of the first end, are positioned outside of the hollow body.

8. The three electrode cell as recited in claim 6 wherein the hollow body is formed of a ceramic material.

9. The three electrode cell as recited in claim 6 wherein the housing further includes a first plunger configured for being inserted into a first end of the bore to contact the anode and a second plunger configured for being inserted into a second end of the bore to contact the cathode.

10. The three electrode cell as recited in claim 9 wherein the first plunger and the second plunger are formed of stainless steel, tungsten, or nickel coated stainless steel.

11. The three electrode cell as recited in claim 6 wherein the hollow body is formed of a ceramic material or PEEK.

12. A three electrode cell including:
an anode;
a cathode;
a solid electrolyte between the anode and the cathode;
an elongated reference electrode embedded in the solid electrolyte; and
a housing surrounding the anode, the cathode and the solid electrolyte, the reference electrode extending out of the housing,
the housing including a hollow body including a bore receiving the anode, the cathode, and the solid electrolyte, the reference electrode extending through a first hole in the hollow body into the bore,
the housing further includes a casing surrounding the hollow body, the casing including a first hole aligned with the first hole of the hollow body and a second hole aligned with the second hole of the hollow body, the reference electrode extending through the first hole and the second hole of the casing.

13. The three electrode cell as recited in claim 12 wherein the casing includes a first section and a second section that are removably connected to each other,
the housing further including a first plunger configured for being inserted through the first section of the casing and into a first end of the bore to contact the anode and a second plunger configured for being inserted through the second section of the casing and into a second end of the bore to contact the cathode, a first plunger seal being sandwiched between the first plunger and the first section of the casing, a second plunger seal being sandwiched between the second plunger and the second section of the casing.

14. The three electrode cell as recited in claim 12 wherein the housing further includes a first adapter configured for being inserted through the casing and into the hollow body and a second adapter configured for being inserted through the casing and into the hollow body,
the first adapter including a first hole configured for the reference electrode to pass through,
the second adapter including a second hole configured for the reference electrode to pass through,

15. The three electrode cell as recited in claim 14 wherein the first adapter includes a first inner adapter section configured for being inserted through the casing and into the hollow body and a second inner adapter section configured for being inserted through the casing and into the hollow body,
a first inner seal being sandwiched between the first inner adapter section and the hollow body, and a second inner seal being sandwiched between the second inner adapter section and the hollow body.

16. The three electrode cell as recited in claim 15 wherein the housing further includes a first outer adapter section configured for being inserted into the first inner adapter section and a second outer adapter section configured for being inserted into the second inner adapter section,
the first inner adapter section including a first hole forming a portion of the first hole of the first adapter, and the first outer adapter section including a first hole forming a portion of the first hole of the first adapter,
the second inner adapter section including a second hole forming a portion of the second hole of the second adapter, and the second outer adapter section including a second hole forming a portion of the second hole of the second adapter,
a first outer seal being sandwiched between the first inner adapter section and the first outer adapter section, and a second outer seal being sandwiched between the second inner adapter section and the second outer adapter section.

17. A method of constructing a three electrode cell comprising:
stacking an anode, a cathode, and a solid electrolyte in a hollow body of a housing, the solid electrolyte being between the anode and the cathode; and
inserting an elongated reference electrode through the hollow body and the solid electrolyte.

18. The method as recited in claim 17 further comprising, after the stacking and before the inserting:
installing a casing of the housing onto the hollow body; and
inserting a first adapter through the casing and into contact with the hollow body and inserting a second adapter through the casing and into contact with the hollow body,
the inserting of the reference electrode including inserting a first end the reference electrode through the first adapter, through the casing, through the hollow body and through the second adapter.

19. The method as recited in claim 17 further comprising, prior to the stacking, installing a portion of a first plunger into the hollowing body,
the stacking including stacking the anode, the cathode, and the solid electrolyte in the hollow body on the portion of the first plunger.
